(19) United States
(12) Patent Application Publication
(10) Pub. No.: US 2014/0359314 A1
(43) Pub. Date: Dec. 4, 2014

(54) COMPUTER SYSTEM AND ITS POWER ADAPTER WITH IMAGE PROJECTION FUNCTION

(71) Applicant: Quanta Computer Inc., TAOYUAN SHIEN (TW)

(72) Inventors: Sheng-Tzu SU, Taipei City (TW); Chien-Hung LIU, Guishan Township (TW); Pei-Te LIU, Taipei City (TW)

(73) Assignee: Quanta Computer Inc., TAOYUAN SHIEN (TW)

(21) Appl. No.: 14/070,342

(22) Filed: Nov. 1, 2013

(30) Foreign Application Priority Data
May 30, 2013 (TW) 102119132

(51) Int. Cl. G06F 1/26

(52) U.S. Cl. CPC G06F 1/26
USPC 713/300; 307/80

(57) ABSTRACT

A computer system and its power adapter with image projection function are provided. The computer system includes an electronic device and a power adapter. The power adapter includes a waveform-transforming module and an image-projecting module electrically connected to the waveform-transforming module. When the power adapter electrically connects to both a power source and the electronic device, the waveform-transforming module provides power to the electronic device and the image-projecting module, and the electronic device provides image signals to the image-projecting module.

### CROSS-REFERENCE TO RELATED APPLICATIONS

This application claims priority to Taiwan Application Serial Number 102119132, filed May 30, 2013, which is herein incorporated by reference.

### FIELD OF THE INVENTION

The disclosure relates to a power adapter. More particularly, the disclosure relates to a computer system and its power adapter with image projection function.

### BACKGROUND

Currently, a conventional USB (Universal Serial Bus) battery charger for a portable electric device (e.g., a mobile phone or an electronic paper reader) normally has a base having a USB female connector at one end, and an AC power plug set at the other end of the base. The USB female connector is used for connecting a USB male connector at one end of a cable; the AC power plug set is used for connecting onto an AC power outlet thereon. When a USB cable is connected between the portable electric device and the USB battery charger, and the portable electric device is charged, the base provides powers from the AC power outlet to the portable electric device via the USB cable.

However, if the USB battery charger, after being connected to the portable electric device, can only provide charging power but without other functions, it is space inefficient and may even be inconvenient for users.

### SUMMARY

In the present disclosure, a computer system and its power adapter with image projection function are provided to overcome the aforementioned shortcomings existing in prior art.

According to one embodiment of the present disclosure, the computer system comprises an electronic device and a power adapter with image projection function. The power adapter comprises a main body, a waveform-transforming module, and an image-projecting module. The main body is formed with a supply-electricity connector and a signal connector. The waveform-transforming module is disposed in the main body, electrically connected to the supply-electricity connector, and used for rectifying and transforming a supply power. The image-projecting module is disposed in the main body, electrically connected to the waveform-transforming module and the signal connector. When the supply-electricity connector is electrically connected to a power source, and the signal connector is electrically connected to the electronic device, the waveform-transforming module provides a first power supply to the electronic device and the image-projecting module, and the electronic device provides an image signal to the image-projecting module via the signal connector.

According to one or more embodiments of the present disclosure, when the supply-electricity connector is separated from the power source, and the signal connector is electrically connected to the electronic device, the electronic device provides a second power supply and the image signal to the image-projecting module via the signal connector, wherein a voltage of the first power supply is higher than a voltage of the second power supply.

According to one or more embodiments of the present disclosure, the power adapter further comprises a first controller, and the electronic device comprises a second controller. The first controller is electrically connected to the waveform-transforming module and the image-projecting module. When the supply-electricity connector is connected to the power source, and after the first controller determines that the second controller of the electronic device complies a predetermined protocol, the first controller enables the waveform-transforming module to provide the first power supply to the electronic device and the image-projecting module. Otherwise, after the first controller determines that the second controller does not comply the predetermined protocol, the first controller enables the waveform-transforming module to provide a third power supply to the electronic device and the image-projecting module, wherein a voltage of the first power supply is higher than a voltage of the third power supply.

According to one or more embodiments of the present disclosure, the image-projecting module comprises an image processing unit and a projection lens. The image processing unit is disposed in the main body, and used for processing the image signal to be an image. The projection lens is electrically connected to the image processing unit, and used for projecting the image outwardly.

According to one or more embodiments of the present disclosure, the power adapter further comprises a retractable member. The retractable member retractably is disposed on the main body, is provided with an opening thereon, and used for extending outwards and retracting inwards the main body, respectively. The projection lens is disposed in the retractable member and moved along with the retractable member. When the retractable member extends outwards from the main body, the opening is revealed, and the projection lens can project the image outwardly through the opening.

As what has been disclosed above, since the power adapter of the present disclosure simultaneously provides an image projection function and a power supplying function, the power adapter of the present disclosure is not only a normal power adapter, but also can be an image projection device. Thus, a normal projector is not required to be additionally purchased, thereby to avoid occupying room.

### BRIEF DESCRIPTION OF THE DRAWINGS

The present disclosure will be apparent to those skilled in the art by reading the following detailed description of a preferred embodiment thereof, with reference to the attached drawings, in which:

FIG. 1 is a schematic view showing a computer system according to one embodiment of the present disclosure;

FIG. 2A is a block diagram showing a power adapter electrically connecting to both a power source and an electronic device according to the embodiment of the present disclosure;

FIG. 2B is a block diagram showing a power adapter separating from a power source according to the embodiment of the present disclosure;

FIG. 3A is a schematic view showing an image-projecting module being retracted according to another embodiment of the present disclosure;

FIG. 3B is a schematic view showing an image-projecting module being extended according to another embodiment of the present disclosure;

FIG. 3C is a schematic view showing an image-projecting module of a power adapter according to one another embodiment of the present disclosure.

### DETAILED DESCRIPTION

The spirit of the disclosure will be described clearly through the drawings and the detailed description as follows. Any of those of ordinary skills in the art can make modifications and variations from the technology taught in the disclosure after understanding the embodiments of the disclosure, without departing from the sprite and scope of the disclosure.

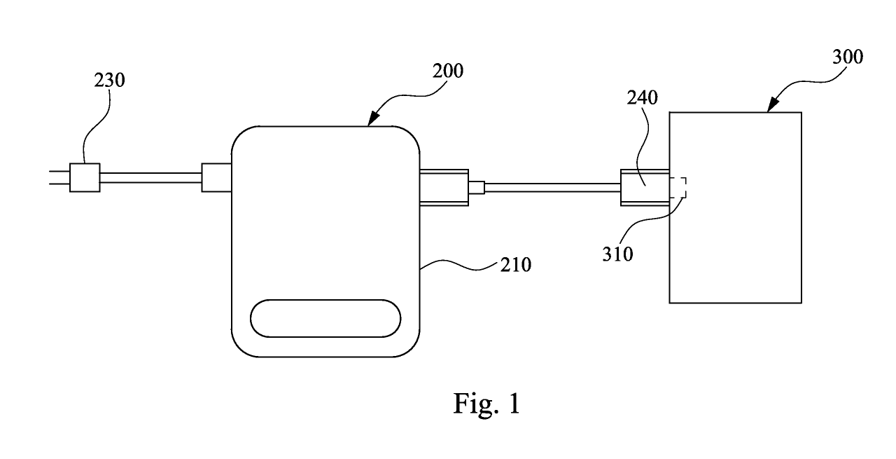

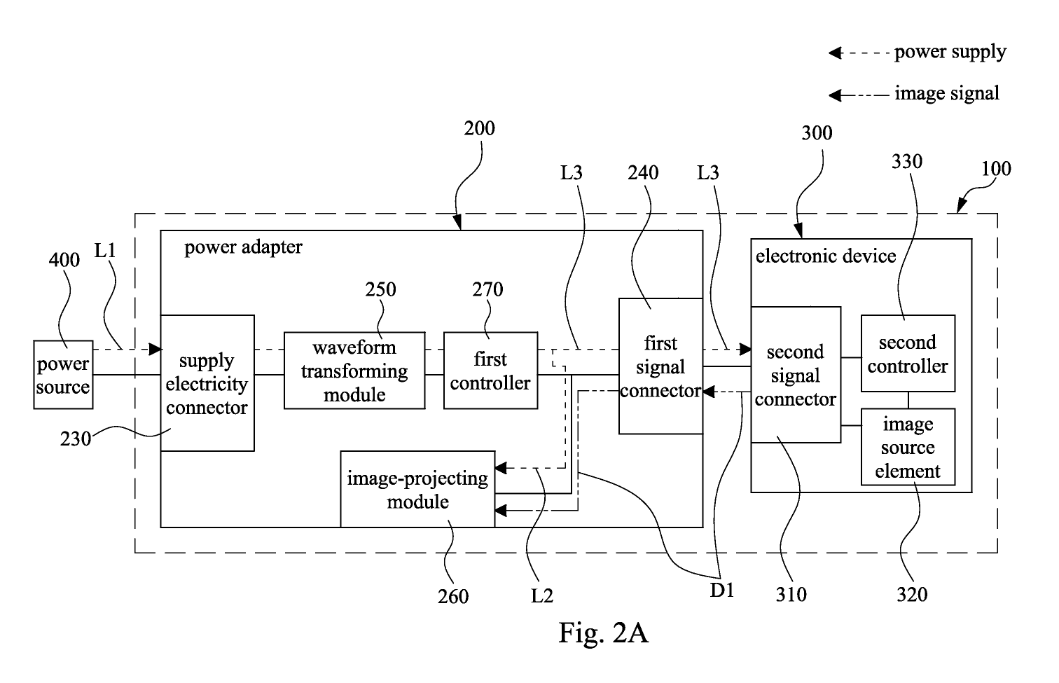

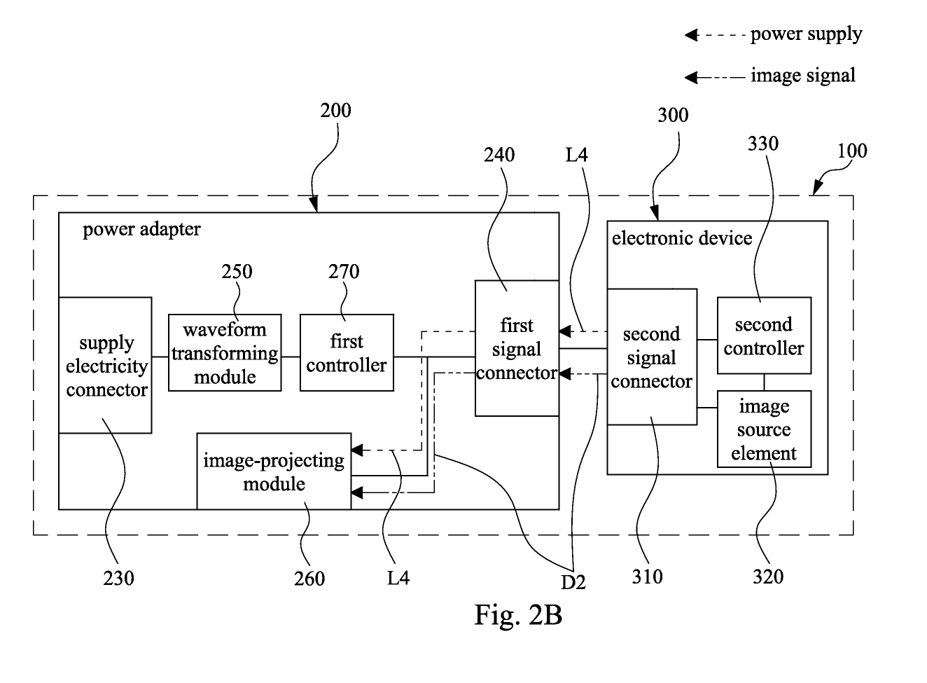

Reference is now made to FIG. 1 and FIG. 2, in which FIG. 1 is a schematic view showing a computer system 100 according to one embodiment of the present disclosure, and FIG. 2A is a block diagram showing a power adapter 200 electrically connecting to both a power source 400 and an electronic device 300 according to the embodiment of the present disclosure.

The computer system 100 comprises an electronic device 300 and a power adapter 200 with image projection function. The power adapter 200 comprises a main body 210, a waveform-transforming module 250, and an image-projecting module 260. The main body 210 is formed with a supply-electricity connector 230 and a first signal connector 240, which are exposed outwards from the main body 210. The waveform-transforming module 250 is disposed in the main body 210 (e.g., an outer case), electrically connected to the supply-electricity connector 230, and rectifies supply power (i.e., to transform AC power into DC power) and transforms the supply power (i.e., to increase or decrease the voltage of the supply power). The image-projecting module 260 is disposed in the main body 210, electrically connected to the waveform-transforming module 250 and the first signal connector 240. The electronic device 300 comprises an image source element 320 (e.g., data storing media) and a second signal connector 310 electrically connected to the image source element 320.

As shown in FIG. 2A, when the first signal connector 240 is electrically connected to the second signal connector 310, and the supply-electricity connector 230 is electrically connected to a power source (or power supply) 400, the power source 400 provides main power supply (See dashed line L1) to the power adapter 200 via the supply-electricity connector 230. The voltage of the main power supply (See dashed line L1), for example, is in a range of 100 to 240 volts in AC power. The waveform-transforming module 250 transforms the main power supply (See dashed line L1) into DC power from AC power, and reduces the voltage of the main power supply (See dashed line L1) into first power supply (See dashed lines L2, L3), and the voltage of the first power supply (See dashed lines L2, L3), for example, is in a range of 5 to 20 volts in DC power. After that, the waveform-transforming module 250 provides first power supply (See dashed lines L2, L3) to the image-projecting module 260 and the electronic device 300 at the same time.

Furthermore, since the first signal connector 240 is electrically connected to the second signal connector 310, the electronic device 300 obtains first power supply (See dashed lines L3) via the first signal connector 240 and the second signal connector 310, and provides an image signal (See long dotted line D1) of the image source element 320 to the image-projecting module 260 via the first signal connector 240 and the second signal connector 310. Therefore, the electronic device 300 works by using the first power supply (See dashed lines L3), and the image-projecting module 260 projects an image outwardly by using the first power supply (See dashed lines L2) and the image signal (See long dotted line D1).

FIG. 2B is a block diagram showing a power adapter 200 separating from a power source 400 according to the embodiment of the present disclosure. On the other hand, as shown in FIG. 2A and FIG. 2B, when the supply-electricity connector 230 is separated from the power source 400 (FIG. 2A) for disconnecting to the power source 400, but the first signal connector 240 and the second signal connector 310 still electrically connect with each other, the electronic device 300 no longer obtains first power supply (See dashed lines L3) from the power adapter 200, and instead, the electronic device 300 provides second power supply (See dashed lines L4) to the image-projecting module 260 of the power adapter 200 via the first signal connector 240 and the second signal connector 310. The voltage of the second power supply (See dashed lines L4), for example, is 5 volts in DC power, and is lower than the voltage of the first power supply.

Also, the electronic device 300 still provides image signal (See long dotted line D2) to the image-projecting module 260 via the first signal connector 240 and the second signal connector 310. Thus, after the supply-electricity connector 230 is separated from the power source 400 (FIG. 2A) for disconnecting to the power source 400, the electronic device 300 simultaneously provides the second power supply (See dashed lines L4) and the image signal (See long dotted line D2) to the image-projecting module 260, and the image-projecting module 260 projects an image outwardly by using the second power supply (See dashed lines L4) and the image signal (See long dotted line D2).

The aforementioned electronic device 300 is not limited to a certain type, and for example, the aforementioned electronic device 300 can be a notebook computer, a digital camera, a mobile phone, a panel computer or other similar portable device. The image-projecting module 260 for example, can be a micro-type projector (e.g., Pico projector). The supply-electricity connector 230 can be AC power-plug pins, and the supply-electricity connector 230 is not limited to form on the main body 210 directly, or an end of a cable (FIG. 1) of the main body 210. The first signal connector 240 is not limited to form on the main body 210 directly, or an end of a cable (FIG. 1) of the main body 210. Also, the first signal connector 240 is not limited to be a format of Universal Serial Bus (USB), Video Graphics Array (VGA) or High-Definition Multimedia Interface (HDMI) etc, and the first signal connector 240 also is not limited to be a male or female connector in those formats. The second signal connector 310 is not limited to form on the electronic device 300 directly, or an end of a cable. Also, the second signal connector 310 is not limited to be a format of Universal Serial Bus (USB, Video Graphics Array (VGA) or High-Definition Multimedia Interface (HDMI) etc, and the second signal connector 310 also is not limited to be a male or female connector in those formats. Nevertheless, the first signal connector 240 and the second signal connector 310 are the same in format, and the first signal connector 240 and the second signal connector 310 respectively are a male connector and a female connector, which are complementary to each other.

In addition, as shown in FIG. 2A and FIG. 2B, the image-projecting module 200 further comprises a first controller 270 electrically connected to the first signal connector 240, the waveform-transforming module 250, and the image-projecting module 260. The electronic device 300 further comprises a second controller 330 electrically connected to the second signal connector 310 and the image source element 320. For example, in the embodiment, both of the first controller 270 and the second controller 330 are controller chips complying with a USB power delivery (USB PD) format, and both of the first controller 270 and the second controller 330 comply with a predetermined protocol.

Therefore, when the first signal connector 240 is electrically connected to the second signal connector 310, and the supply-electricity connector 230 is electrically connected to the power source 400, the first controller 270 determines whether the second controller 330 complies the predetermined protocol. After the first controller 270 determines that the second controller 330 complies the aforementioned predetermined protocol, the first controller 270 enables the waveform-transforming module 250 to provide the aforementioned first power supply (See dashed lines L3) to the electronic device 300 and the image-projecting module 260.

On the contrary, when the first signal connector 240 is electrically connected to the second signal connector 310, and the supply-electricity connector 230 is electrically connected to the power source 400, and after the first controller 270 determines that the second controller 330 does not comply the aforementioned predetermined protocol, the first controller 270 enables the waveform-transforming module 250 to provide third power supply (See dashed lines L2, L3) to the electronic device 300 and the image-projecting module 260, respectively. The voltage of the third power supply, for example, is 5 volts in DC power, and is lower than the voltage of the first power supply.

Therefore, the electronic device 300 works by using the third power supply, and the image-projecting module 260 projects an image outwardly by using the third power supply and the image signal.

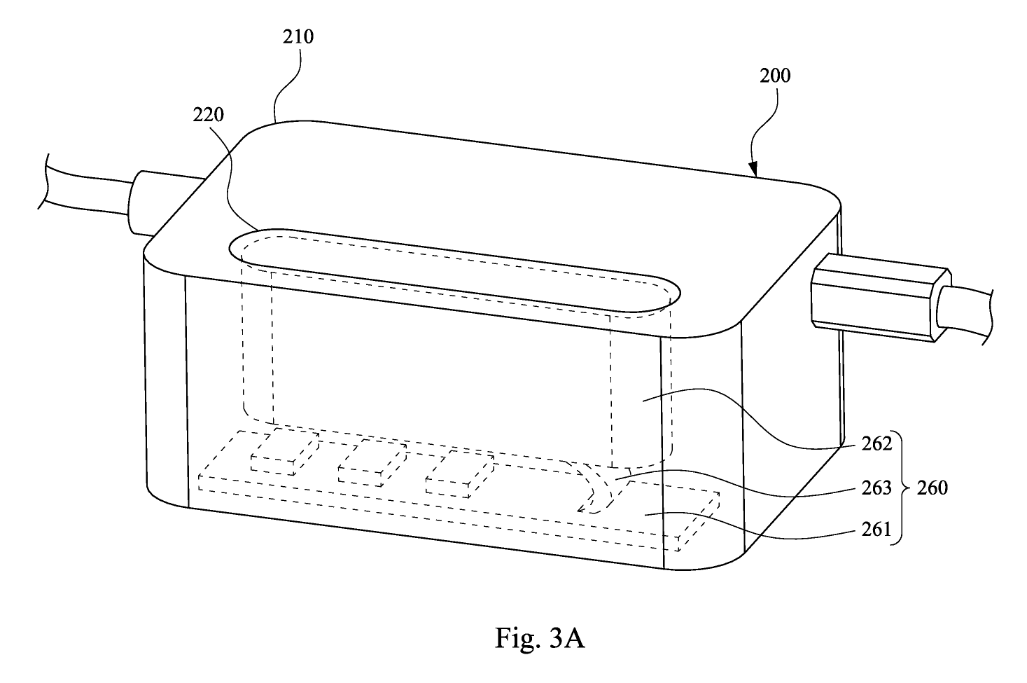

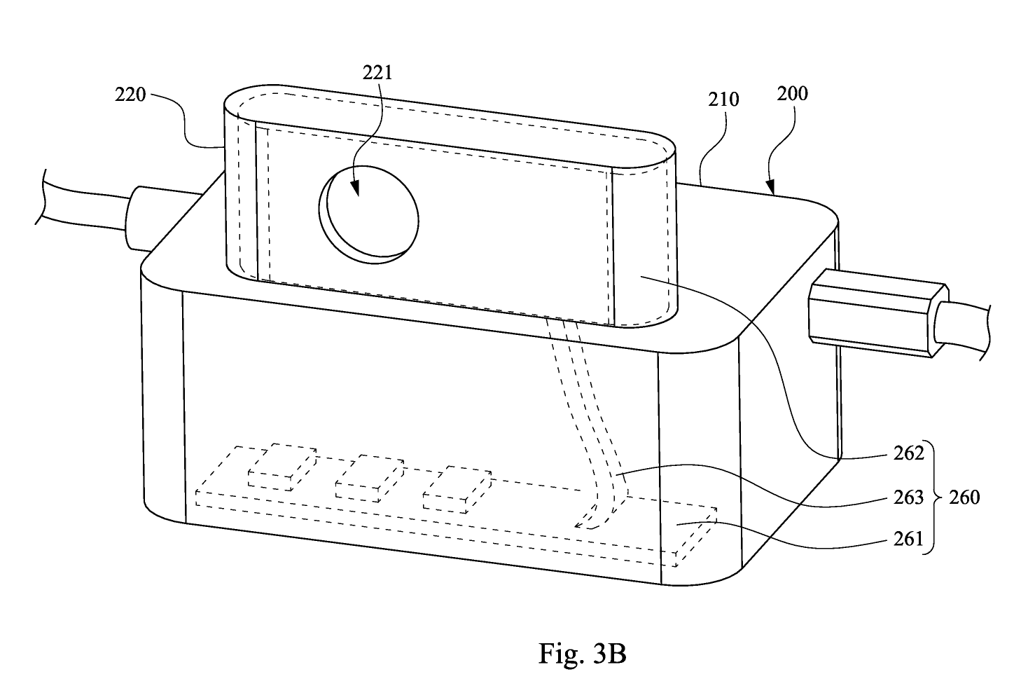

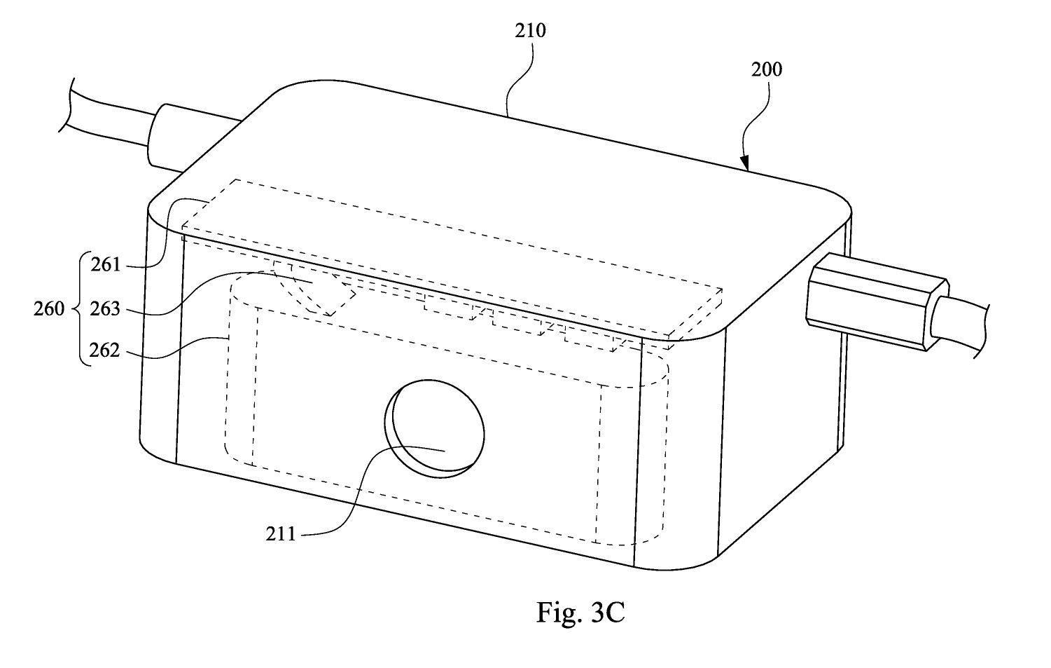

Reference is now made to FIG. 3A and FIG. 3B in which FIG. 3A is a schematic view showing an image-projecting module 260 being retracted according to another embodiment of the present disclosure, and FIG. 3B is a schematic view showing an image-projecting module 260 being extended according to another embodiment of the present disclosure.

As shown in FIG. 3A and FIG. 3B, the image-projecting module 260 comprises an image processing unit 261 and a projection lens 262. The image processing unit 261 is disposed in the main body 210, and processes the aforementioned image signal (See long dotted line D1, FIG. 2A) to be the aforementioned image. The projection lens 262 is electrically connected to the image processing unit 261 through a flex flat cable 263, and projects the aforementioned image outwardly.

Substantially, the power adapter 200 further comprises a retractable member 220 having an opening 221 thereon. The retractable member 220 is retractably disposed on the main body 210, thus, the retractable member 220 can extend outwards from the main body 210 or retract inside the main body 210. The projection lens 262 is disposed in the retractable member 220 and is moved along with the retractable member 220. When the retractable member 220 extends outwards from the main body 210, the opening 221 is revealed, and the projection lens 262 can project the aforementioned image outwards the main body 210 through the opening 221.

Thus, when the image-projecting module 260 is unused, the retractable member 220 can be pressed into the main body 210 to store the projection lens 262 in the main body 210 so as to protect the projection lens 262 from damage.

What shall be addressed is that a latch structure (not shown in figures) is arranged between the retractable member 220 and the main body 210, so that after the retractable member 220 is pressed into the main body 210, the retractable member 220 can be fixed in the main body 210, after that, when the retractable member 220 is pressed again, the retractable member 220 can be released by a spring and extended outwards from the main body 210. Also, the latch structure can be a “push-lock and push-release type”, “push-push type”, “push-lock and push-open type”, or “alternate type” of latch structure.

However, the disclosure is not limited to that type of image-projecting module 260. FIG. 3C is a schematic view showing an image-projecting module 260 of a power adapter 200 according to one another embodiment of the present disclosure. As shown in FIG. 3C, the projection lens 262 can be designed as an immobile element in the main body 210 by design personnel, thus, the projection lens 262 can project the aforementioned image outwards the main body 210 through an aperture 211 formed on a surface of the main body 210.

To sum up, the power adapter with image projection function provided by the disclosure provides advantages as follows:

(1) When using in meeting, the power adapter with image projection function provided by the disclosure can be moved to adjust its projection angle or direction thereof freely, so as to prevent from the electronic device (such as notebook computer) and a normal projector unable to put together due to the size limitations of the normal projector and the electronic device (such as notebook computer) itself.

(2) When using in meeting, the power adapter with image projection function provided by the disclosure can be acted as a personal auxiliary projector. When a user uses conference slides provided by a normal projector in the meeting, and needs some relevant reference to compare with one of the conference slides, the user can use the personal auxiliary projector as supplementing illustration, so that the user does not need to repeatedly switch the screen contents of the computer to be shown on the conference slide.

(3) When not using in meeting, the power adapter with image projection function provided by the disclosure can be acted as a digital photo album or a marquee bulletin board when projecting information or image onto a surface.

(4) when a normal projector and an electronic device (such as notebook computer) are needed simultaneously, by using the computer system provided by the disclosure to integrate the normal projector and an adopter together, the number and volume of their accessories can be decreased.

Although the present disclosure has been described with reference to the preferred embodiments thereof, it is apparent to those skilled in the art that a variety of modifications and changes may be made without departing from the scope of the present disclosure which is intended to be defined by the appended claims.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A power adapter with image projection function comprising:
a main body having a supply-electricity connector and a signal connector;
a waveform-transforming module disposed in the main body, electrically connected to the supply-electricity connector, and used for rectifying and transforming a supply power; and
an image-projecting module disposed in the main body, electrically connected to the waveform-transforming module and the signal connector,
when the supply-electricity connector is electrically connected to a power source, and the signal connector is electrically connected to an electronic device, the waveform-transforming module provides a first power supply to the electronic device and the image-projecting module, and the electronic device provides an image signal to the image-projecting module via the signal connector.

2. The power adapter with image projection function according to claim 1, wherein when the supply-electricity connector is separated from the power source, and the signal connector is electrically connected to the electronic device, the electronic device provides a second power supply and the image signal to the image-projecting module via the signal connector, wherein a voltage of the first power supply is higher than a voltage of the second power supply.

3. The power adapter with image projection function according to claim 1, further comprising:
a first controller electrically connected to the waveform-transforming module and the image-projecting module,
wherein when the supply-electricity connector is connected to the power source, and after the first controller determines that a second controller of the electronic device complies a predetermined protocol, the first controller enables the waveform-transforming module to provide the first power supply to the electronic device and the image-projecting module,
after the first controller determines that the second controller does not comply the predetermined protocol, the first controller enables the waveform-transforming module to provide a third power supply to the electronic device and the image-projecting module, wherein a voltage of the first power supply is higher than a voltage of the third power supply.

4. The power adapter with image projection function according to claim 1, wherein the image-projecting module comprises:
an image processing unit disposed in the main body, and used for processing the image signal to be an image; and
a projection lens electrically connected to the image processing unit, and used for projecting the image outwardly.

5. The power adapter with image projection function according to claim 4, further comprising:
a retractable member retractably disposed on the main body, used for extending outwards and retracting inwards the main body, respectively, wherein the retractable member is provided with an opening thereon, and the projection lens is disposed in the retractable member and moved along with the retractable member,
when the retractable member extends outwards from the main body, the opening is revealed, and the projection lens is capable of projecting the image outwardly through the opening.

6. A computer system comprising:
an electronic device; and
a power adapter with image projection function, comprising:
a main body having a supply-electricity connector and a signal connector;
a waveform-transforming module disposed in the main body, electrically connected to the supply-electricity connector, and used for rectifying and transforming a supply power; and
an image-projecting module disposed in the main body, electrically connected to the waveform-transforming module and the signal connector,
when the supply-electricity connector is electrically connected to a power source, and the signal connector is electrically connected to the electronic device, the waveform-transforming module provides a first power supply to the electronic device and the image-projecting module, and the electronic device provides an image signal to the image-projecting module via the signal connector.

7. The computer system according to claim 6, wherein when the supply-electricity connector is separated from the power source, and the signal connector is electrically connected to the electronic device, the electronic device provides a second power supply and the image signal to the image-projecting module via the signal connector, wherein a voltage of the first power supply is higher than a voltage of the second power supply.

8. The computer system according to claim 6, wherein the power adapter further comprising:
a first controller electrically connected to the waveform-transforming module and the image-projecting module; and
the electronic device comprises a second controller,
wherein when the supply-electricity connector is connected to the power source, and after the first controller determines that the second controller of the electronic device complies a predetermined protocol, the first controller enables the waveform-transforming module to provide the first power supply to the electronic device and the image-projecting module,
after the first controller determines that the second controller does not comply the predetermined protocol, the first controller enables the waveform-transforming module to provide a third power supply to the electronic device and the image-projecting module, wherein a voltage of the first power supply is higher than a voltage of the third power supply.

9. The computer system according to claim 6, wherein the image-projecting module comprises:
an image processing unit disposed in the main body, and used for processing the image signal to be an image; and
a projection lens electrically connected to the image processing unit, and used for projecting the image outwardly.

10. The computer system according to claim 9, wherein the power adapter further comprising:
a retractable member retractably disposed on the main body, used for extending outwards and retracting inwards the main body, respectively, wherein the retractable member is provided with an opening thereon, and the projection lens is disposed in the retractable member and moved along with the retractable member,
when the retractable member extends outwards from the main body, the opening is revealed, and the projection lens is capable of projecting the image outwardly through the opening.
